(19) United States
(12) Patent Application Publication
(10) Pub. No.: US 2023/0390877 A1
(43) Pub. Date: Dec. 7, 2023

(54) Machine for the Automatic Assembling of a Plurality of Components

(71) Applicant: Velomat S.R.L., Imola (Bologna) (IT)

(72) Inventor: Carmine D'ELETTO, San Giovanni Teatino (Chieti) (IT)

(21) Appl. No.: 18/249,539

(22) PCT Filed: Oct. 18, 2021
(86) PCT No.: PCT/IB2021/059567

§ 371 Date: Apr. 18, 2023

(30) Foreign Application Priority Data
Oct. 19, 2020 (IT) 102020000024637

(51) Int. Cl. B23P 21/00

(52) U.S. Cl. CPC B23P 21/006

(57) ABSTRACT

A machine for the automatic, continuous-cycle assembling of a plurality of components for making an assembly comprises a conveyor, movable to transport a first of the plurality of components along a working path through successions of alternating advances and pauses; a conveyor actuator, configured to drive the conveyor to move intermittently; and one or more manipulating units configured to perform operations on the components in a working zone. The manipulating unit includes an interface element, movable by means of an actuating unit along a manipulating trajectory between a working position and a rest position, configured to pick up a second component and assemble it with the first component. The machine comprises a control unit configured to control the conveyor actuator in response to a synchronization signal and to control the movement of the actuating units according to a predetermined law of motion synchronously with the synchronization signal.

### TECHNICAL FIELD

This invention relates to a machine for automatically assembling a plurality of components to make an assembly.

### BACKGROUND ART

More specifically, the invention addresses the field of machines that operate in a continuous cycle by intermittent motion of the components, meaning that the components are moved between a plurality of working stations, at each of which a corresponding manipulating unit assembles another component or performs quality checks. One example of a machine of this kind is described in patent document U.S. Pat. No. 5,636,425A.

In these machines, a linear or rotary conveyor moves the components along a working path while they are progressively assembled. The linear conveyor is moved by a conveyor actuator. The motion of the conveyor actuator is then converted into intermittent motion with period and frequency.

Depending on the position of the component, the machine drives the actuators of the manipulating units which in turn move an interface element that is adapted, for example, to pick and place a component. The motions of the conveyor actuator and of the manipulating unit actuators must therefore be synchronized.

In prior art machines, this type of synchronization is carried out in a completely mechanical manner. In other words, the motion of the conveyor actuator is converted into an intermittent motion of the conveyor by a series of cams and/or kinematic mechanisms. The same occurs in the manipulating units where, after starting the operation based on the mechanical synchronization with the conveyor actuator, the actuators are moved by cams and kinematic mechanisms according to a given time sequence.

These solutions are, however, very complex to design and implement. Further, should it become necessary to modify the process parameters (for example, speed, acceleration and deceleration, pause time and feed space and time of the conveyor) these solutions are not flexible and the machine has to be completely renovated. Moreover, modifying the working trajectory of the interface elements, should this be necessary, is a painstaking task.

Also known are solutions in which synchronization is carried out electronically by synchronizing the motors of the manipulating units with a central motor that rotationally drives a carousel. A solution of this kind is described in document EP1338372A1. At present, however, these systems are not very reliable and relatively inflexible in that they are applied only to specific types of work cycles and on machines having actuators that are not very complex. In describing the systems of this kind, therefore, the prior art describes electronic synchronization solutions but not how such solutions can be applied to more complex assembling machines.

Other solutions regarding apparatuses for automatically assembling a plurality of components are described in the following documents: WO2016023101A1, EP1304187A1, EP0286546A1 and US2003208903A1.

### DISCLOSURE OF THE INVENTION

This disclosure has for an aim to provide an automatic assembling machine and method to overcome the above mentioned disadvantages of the prior art.

This aim is fully achieved by the machine and method of this disclosure as characterized in the appended claims.

According to an aspect of it, this disclosure provides a machine for the automatic, continuous-cycle assembling of a plurality of components for making an assembly, that is to say, for making a succession of assemblies in a continuous cycle.

The machine comprises a conveyor. The conveyor is movable to transport a first of the plurality of components along a working path. The conveyor is movable through a succession of advances alternated with a corresponding succession of pauses to define a corresponding plurality of working stations. More specifically, each pause of the conveyor defines a corresponding working station.

The machine comprises a conveyor actuator. The conveyor actuator is configured to drive the conveyor so it moves intermittently between the working stations of the plurality of working stations.

The machine comprises one or more manipulating units. Each manipulating unit is positioned in a respective working station along the working path. Each manipulating unit is configured to perform a specific operation on the components in a working zone of the respective working station.

In an embodiment, each (or at least one) manipulating unit includes an interface element. The interface element is movable along a manipulating trajectory, preferably between a working position, where it is inside the corresponding working zone, and a rest position, where it is outside the corresponding working zone.

In an example embodiment, the one or more manipulating units comprise at least one Delta manipulating unit. In an example embodiment, the one or more manipulating units comprise at least one 2DOF PRRRP manipulating unit.

Each (or at least one) manipulating unit comprises an actuating unit. The actuating unit is configured to move the interface element, preferably between the working position and the rest position.

At least one manipulating unit is configured to pick up a second component of the plurality of components. At least one manipulating unit is configured to assemble the second component with the first component positioned on the conveyor.

It should be noted that according to an aspect of this disclosure, the conveyor comprises a predetermined number of operational positions (or locations) which can define corresponding working stations. More specifically, each operational position defines a working station the moment a manipulating unit is placed on it in such a way that the operational position becomes suitable, to all intents and purposes, for performing an operation on the assembly. According to an aspect of this disclosure, therefore, the working stations of the plurality can be set and, if necessary, modified, in number up to a maximum equal to the number of operational positions available on the conveyor. That means the number of working stations on the same conveyor can be adapted to specific assembling requirements without having to make substantial changes to machine parts or dimensions. For example, the number of operational positions may be in the range of between 2 and 16 operational positions. The operational positions may be 2, 4, 6, 8, 12, 14 or 16 in number.

In an embodiment, the machine comprises a (central) control unit. The control unit is configured to electronically control the conveyor actuator, preferably in response to a synchronizing signal.

In an embodiment, the actuating units include electronically controllable actuators. In an embodiment, the actuating units include only electronically controllable actuators.

The control unit is programmed to control the movement of the actuating units according to a predetermined law of motion, defining the manipulating trajectory of each interface element. The control unit is programmed to control the movement of the actuating units synchronously relative to the synchronizing signal.

In an embodiment, the control unit is programmed to generate a primary synchronization signal. The control unit is programmed to generate drive signals as a function of the primary synchronization signal. Through the drive signals, the control unit can drive the conveyor actuator to control the movement of the conveyor.

In an embodiment, the primary synchronization signal represents a step defined by the succession of advances of the conveyor. In other words, the synchronization signal might be a sinusoidal signal, a square wave or other type of periodic signal.

The primary synchronization signal defines a predetermined periodicity; this predetermined periodicity may represent the pause times and the advance times; in addition or alternatively, this predetermined periodicity may represent a configuration of the machine in three-dimensional space. Generating a primary synchronization signal (representing a step defined by the succession of advances of the conveyor) and generating a drive signals as a function of the primary synchronizing signal to drive the conveyor actuator to control the movement of the conveyor allow obtaining a particularly effective and flexible control for the machine.

In an embodiment, each actuating unit comprises a real actuator configured to move the interface element.

In an embodiment, the control unit is programmed to generate command signals as a function of the synchronizing signal and/or as a function of the primary synchronization signal, the command signals representing a displacement (or driving action) of each of the one or more manipulating units. In other words, the control unit is programmed to generate, for each manipulating unit (that is, each real actuator included in the manipulating unit) a corresponding command signal to instruct a driver of each manipulating unit to move each real actuator included in the manipulating unit.

In an example embodiment, the function of generating the command signals is centralized in the control unit.

In other example embodiments, each manipulating unit comprises a local control unit. The local control unit is programmed to generate a secondary synchronization signal. The secondary synchronization signal is synchronized with the primary synchronization signal.

The presence of the local control unit for each manipulating unit allows isolating the controls so that a manipulating unit can, if necessary, be replaced without having to re-program the central control unit but simply by synchronizing the new manipulating unit with the primary synchronization signal.

Each local control unit is configured to generate command signals responsive to the secondary synchronization signal. That way, the local control unit can instruct the real actuator to move the interface element. Instead, in the embodiment in which the function of generating the command signals is centralized in the control unit, the secondary synchronization signals (where present) are generated centrally in the central control unit. The command signals (for the motor of the conveyor and for the station actuators) and/or the secondary synchronization signals are distributed through a bus (to the control units of the conveyor and of the station actuators).

In an embodiment, each actuating unit includes a first linear actuator. In an embodiment, each actuating unit includes a second linear actuator. The first and/or the second linear actuator are movable along a first direction. In an embodiment, the actuating unit comprises an articulated structure. The articulated structure is connected to the interface element. The articulated structure is connected to the first linear actuator and/or to the second linear actuator and is configured to convert a linear movement of the first actuator and of the second actuator into a movement of the interface element along the manipulating trajectory, where the manipulating trajectory is contained in a plane.

In other words, the manipulating unit (actuating unit) is of the Delta Robot type. The use of a Delta Robot manipulating unit allows increasing the precision of the machine and makes it easier to control.

In an embodiment, the predetermined law of motion is programmable.

The machine comprises a user interface, connected to the control unit. Through the user interface, a user can send configuration data to the control unit.

The configuration data at least represent the predetermined law of motion of an interface element of at least one manipulating unit.

In an embodiment, the configuration data represent the manipulating trajectory of the interface element of each manipulating unit. In an embodiment, the configuration data include one or more of the following parameters:
a pickup point, expressed in planar Cartesian coordinates;
distance towards the pickup point, along a vertical direction;
distance away from the pickup point, along a vertical direction;
a set-down point, expressed in planar Cartesian coordinates;
distance towards the set-down point, along a vertical direction;
distance away from the set-down point, along a vertical direction;
a transition point between the pickup point and the set-down point, expressed in planar Cartesian coordinates;
a transition point between the set-down point and the pickup point, expressed in planar Cartesian coordinates.

In an embodiment, the machine comprises a plurality of sensors, configured to detect one or more physical quantities on the assembled components. The plurality of sensors are connected to the control unit which, as a function of the quantities measured, controls the conveyor actuator or communicates with the local control units to control the manipulating units indirectly.

In an embodiment, the conveyor is a turntable. In this embodiment, the working path is at least one portion of a circle.

In an embodiment, the conveyor is a linear conveyor. In this embodiment, the working path is a straight line (a segment).

In an embodiment, the one or more manipulating units comprise one or more of the following types of manipulating units:
a pickup unit configured to pick up a component and to place it on the conveyor;
a set-down unit, configured to pick up an assembly from the conveyor and to set it down outside the machine;
an assembling unit, configured to pick up a component to be assembled from a loading bay and to assemble it with the component positioned on the conveyor;
an inspecting device, configured to capture a control parameter from the component or assembly to perform a quality check.

According to an aspect of it, this disclosure also provides a method for the automatic, continuous-cycle assembling of a plurality of components for making an assembly.

In an embodiment, the method comprises a step of transporting on a conveyor. In the step of transporting, a first of the plurality of components is transported along a working path, preferably through a succession of advances alternated with a corresponding succession of pauses to define a corresponding plurality of working stations.

The method comprises a step of actuating a conveyor actuator to drive the conveyor, preferably so it moves intermittently between the working stations of the plurality of working stations.

The method comprises a step of one or more manipulating units performing a corresponding operation on the components in a working zone of the respective working station.

In the step of performing, at least one of the operations is an operation of assembling a second component with the first component.

The method comprises a step of an actuating unit moving an interface element of each (or at least one) of the one or more manipulating units, preferably between a working position, where it is inside the corresponding working zone, and a rest position, where it is outside the corresponding working zone.

The method comprises a step of controlling by means of a control unit. In the step of controlling, the control unit electronically controls the conveyor actuator, preferably in response to a synchronizing signal.

In the step of controlling, the control unit (directly or indirectly) controls the actuating units according to a predetermined law of motion. The predetermined law of motion defines the manipulating trajectory of each interface element. The control unit controls the actuating units synchronously relative to the synchronizing signal.

In an embodiment of the method, in the step of controlling, the control unit generates a primary synchronization signal. The control unit generates drive signals as a function of the primary synchronization signal. The control unit sends the drive signals to the conveyor actuator to instruct it to move the conveyor.

In an embodiment, the primary synchronization signal represents a step defined by the succession of advances of the conveyor.

In an embodiment of the method, in the step of controlling, for each manipulating unit, a corresponding local control unit of the manipulating unit generates a secondary synchronization signal. The secondary synchronization signal is synchronized with the primary synchronization signal. Each local control unit generates command signals in response to the secondary synchronization signal to instruct the real actuator of the corresponding manipulating unit to drive the interface element.

In an embodiment, the method comprises a step of inspecting. In the step of inspecting, at least one manipulating unit of the one or more manipulating units is an inspecting unit which captures a control parameter from the component or assembly to perform a quality check. In an embodiment, the control parameter represents a quality of the assembling performed.

### BRIEF DESCRIPTION OF THE DRAWINGS

These and other features will become more apparent from the following description of a preferred embodiment, illustrated by way of non-limiting example in the accompanying drawings, in which:

FIG. 1 illustrates an embodiment of a machine for automatically assembling a plurality of components to make an assembly according to this disclosure;

FIG. 2 illustrates another embodiment of the machine of FIG. 1;

FIG. 3 schematically illustrates an actuating unit of the assembling machine of FIG. 1;

FIG. 4 shows a first, a second and a third graph schematically representing the trend over time of a primary synchronization signal, of a first drive signal and of a second drive signal, respectively;

FIG. 5 shows a first, a second and a third graph schematically representing the trend of a secondary synchronization signal, of a first command signal for a first actuator and of a second command signal for a second actuator, respectively.

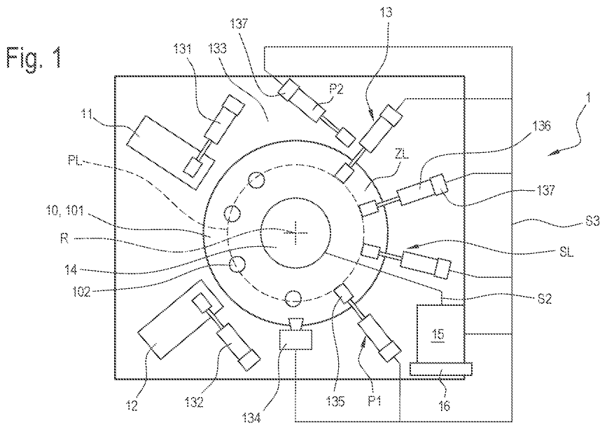

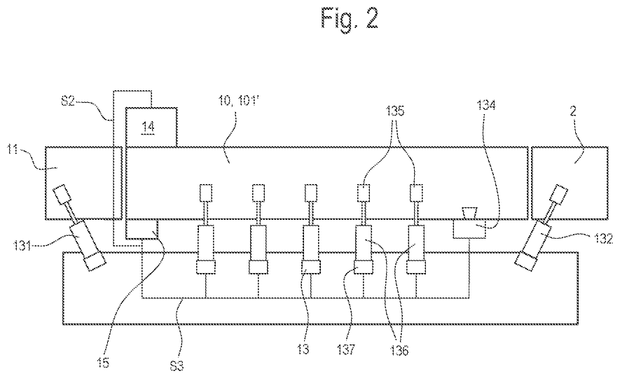

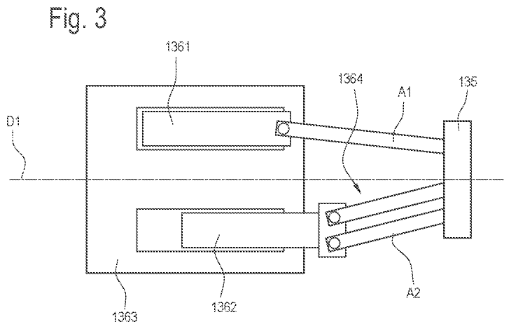

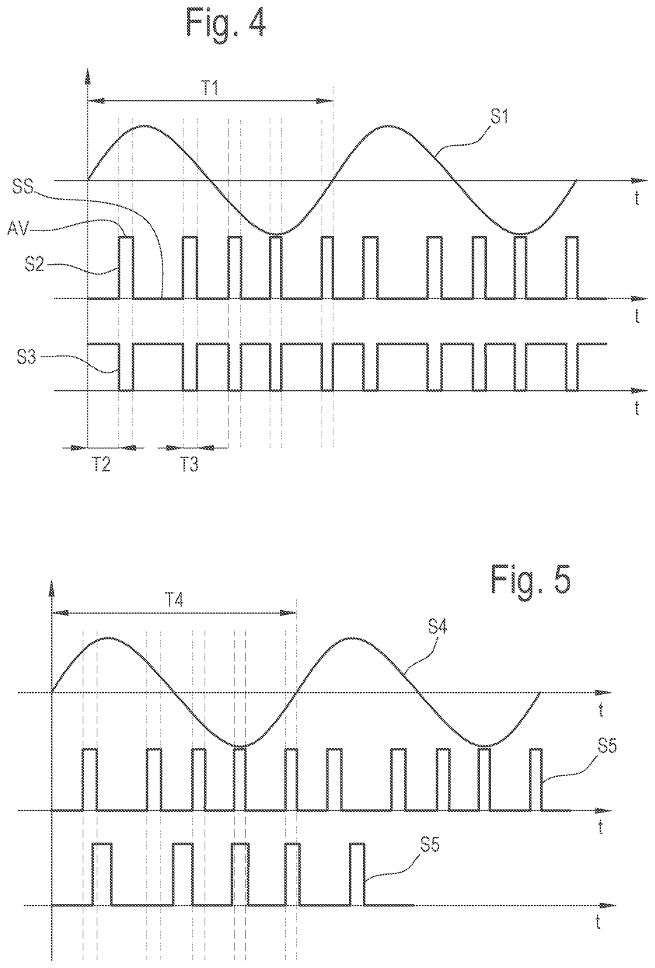

### DETAILED DESCRIPTION OF PREFERRED EMBODIMENTS OF THE INVENTION

With reference to the accompanying drawings, the numeral 1 denotes a machine for assembling a plurality of components to make an assembly. The machine 1 comprises a conveyor 10. The conveyor 10 is configured to transport a first component along a working path PL, along which the first component is assembled with other components of the plurality of components. In an embodiment, the conveyor 10 comprises a turntable 101 that rotates about an axis of rotation R. The turntable 101 comprises a plurality of positions 102, angularly spaced from each other, where the first component is placed.

In an embodiment, the conveyor 10 is a linear conveyor 101′ configured to transport the components and the semi-assemblies along a rectilinear direction. In such a case, the positions 102 are linearly spaced from each other.

The conveyor 10 (the turntable 101) is movable according to a succession of advances AV alternated with corresponding pauses SS. The turntable 101 is characterized by an assembly cycle, having a rotation period T1, in which the turntable 101 completes one full rotation about the axis R.

In an embodiment, the duration of the pauses SS is equal to a pause time T2 and corresponds to the duration of the operation, along the working path PL, that requires the longest time.

In an embodiment, the duration of the advances AV is equal to an advance time T3 and corresponds to the angular space between the working stations divided by the angular rotation speed of the turntable 101.

Thus, the rotation period T1 is equal to the sum of the product of the pause period T2 by the number of working stations n and the product of the advance period T3 by the number of working stations n. As a formula, we can express the relation between the pause times T2, the advance times T3 and the assembling period as follows:

T1=(T2*n)+(T3*n)

It should be noted that the term “rotation period T1” is used to mean the length of time needed for a certain position of the turntable to complete one full rotation of the turntable and return to its starting position.

We also use the term “assembling period”, defined as the length of time needed to complete assembling operations on one product. The assembling period does not necessarily coincide with the rotation period T1. More specifically, the assembling period might be less than the rotation period T1. In such an embodiment, more than one product can be assembled in one rotation period T1. The assembling period might be greater than the rotation period T1. In such an embodiment, the assembly cannot be completed in a single rotation of the turntable but requires at least one portion of the next rotation of the turntable. Lastly, the assembling period might coincide with the rotation period T1. In such a case, for each rotation of the turntable, one assembly is produced.

It should also be borne in mind that the rotation period T1 may also include time intervals in which the turntable rotates in an opposite rotation direction to bring the assembly back to a working station it has already passed through. For the purposes of this disclosure, the rotation period T1 also includes these time intervals, in which the rotation direction is reversed because, for the purposes of the calculation, they can be simulated as additional working stations. Thus, in the above formula, the number of working stations is the number of times the turntable advances, whatever the direction, until the turntable completes its rotation.

The machine 1 comprises a feed conveyor 11. The feed conveyor 11 is configured to convey a first component from an external buffer, which contains a number of first components, to a position near the conveyor 10.

The machine 1 comprises a pickup conveyor 12. The pickup conveyor 12 is configured to convey the assembly from a zone near the conveyor 10 to an external buffer, where the assemblies are stored.

The machine 1 comprises a plurality of manipulating units 13. Each manipulating unit 13 is positioned in a respective working station along the working path PL. The manipulating units 13 of the plurality are configured to perform corresponding operations on the components in a working zone ZL of the corresponding working station SL.

More specifically, the plurality of manipulating units 13 comprises one or more of the following manipulating units 13:
a pickup unit 131;
a set-down unit 132;
an assembling unit 133;
an inspecting unit 134.

In an embodiment, the pickup unit 131 is configured to pick up the first component from the feed conveyor 11 and to set it down at a corresponding position 102 on the turntable 101.

In an embodiment, the set-down unit 132 is configured to pick up the assembly from the turntable 101 and to set it down on the pickup conveyor 12.

In an embodiment, the assembling unit 133 is configured to pick up a corresponding assembly component (second component) and to assemble it with the component (or the semi-assembly) positioned on the turntable 101.

In an embodiment, at least one manipulating unit 13 comprises an interface element 135. The interface element 135 is configured to grab the corresponding component to be assembled with the component (or the semi-assembly) positioned on the turntable 101. The interface element 135 might also be a detecting element, for example, a sensor, configured to capture a control parameter from a component, a semi-assembly or the finished assembly.

More specifically, the interface element 135 is movable between a working position P1, where it is inside the corresponding working zone ZL, and a rest position P2, where it is outside the corresponding working zone ZL.

In an embodiment, at least one manipulating unit 13 comprises an actuating unit 136, configured to move the interface element 135 between the working position P1 and the rest position P2.

The inspecting unit 134 is configured to capture a control parameter from a component or a (semi-)assembly. In an embodiment, the inspecting unit may comprise one or more of the following sensors:
a temperature sensor;
an optical sensor;
a pressure sensor;
a camera;
an electromagnetic wave detector.

The inspecting unit 134 is configured to check the quality of a component to be assembled or the quality of a (semi-)assembly.

In an embodiment, the machine 1 comprises a conveyor actuator 14. The conveyor actuator 14 is configured to drive the conveyor 10. The conveyor actuator 14 is configured to drive the turntable 101 (or the linear conveyor 101′). In an embodiment, the conveyor actuator 14 is an electric motor, for example, a brushless motor or a stepping motor, controlled by a control unit.

The conveyor actuator 14 is connected to the turntable 101 to set it in rotation about the axis of rotation R. More specifically, the conveyor actuator 14 is started intermittently according to the succession of advances AV and pauses SS, in line with the pause times T2 and the advance times T3.

In an embodiment, the machine 1 comprises a control unit 15. The control unit 15 is programmed to control the operation of the machine 1; more specifically, it is programmed to control the movements of the conveyor actuator 14 and of the manipulating units 13 synchronously.

In effect, in a preferred embodiment, the conveyor actuator 14 is controllable electronically by the control unit.

In effect, in a preferred embodiment, each actuating unit 136 is controllable electronically. The actuators of each actuating unit 136 may be fed by any form of power, for example, hydraulic, pneumatic, electrical power, provided they are controllable electronically. Also imaginable are hybrid solutions in which some of the actuators are controlled mechanically or manually. The machine is, however, preferably controlled fully electronically.

In an embodiment, each (or at least one) manipulating unit 13 comprises a local control unit 137.

The local control unit 137 is programmed to control the movement of the corresponding actuating unit 136 (or of the actuators of the corresponding actuating unit 136).

Each local control unit 137 is connected to the control unit 15. The connection may be a wired or wireless connection.

In an embodiment, the control unit 15 is configured to control the conveyor actuator 14 electronically, responsive to a synchronizing signal.

The control unit is programmed to control the movement of the actuating units 136 according to a predetermined law of motion, defining the manipulating trajectory of each interface element 135. The control unit is programmed to control the movement of the actuating units 136 synchronously relative to the synchronizing signal.

Described in detail below is a possible embodiment of how the actuators of the machine 1 are controlled electronically.

In an embodiment, the control unit 15 is programmed to generate a primary synchronization signal S1. The primary synchronization signal S1 is a signal having a certain periodicity, equal to the assembling time T1. In other words, the primary synchronization signal S1 might be viewed as a simulator of a virtual mechanical machine, in which a shaft rotates with a certain frequency, hence with a certain period, namely the assembling period T1.

This electronic stratagem allows gaining and defining a reference for programming the transmission of motion electronically, and not mechanically, as used to be done in the past.

The control unit 15 is therefore programmed to generate a first drive signal S2 as a function of the primary synchronization signal S1. The control unit 15 is programmed to generate the first drive signal S2 as a function of configuration data representing the rotation speed required by the operator and/or the number of stations n, where modifying this number is possible. Therefore, the control unit 15 sends the first drive signal S2 to the conveyor actuator 14 to instruct it to drive the conveyor 10 (that is, the turntable 101). By way of an example only, the first drive signal S2 might be variable between a first value and a second value, where the first value represents a rotation of the conveyor actuator 14, hence an advance AV of the conveyor 10 (that is, of the turntable) and the second value represents an interruption of the conveyor actuator 14, hence a pause SS of the conveyor 10 (that is, the turntable).

In an embodiment, for each manipulating unit 13, the control unit 15 is programmed to generate a second drive signal S3. The second drive signal S3 is sent to the respective local control unit 137, to instruct it to start the corresponding operation at the working station SL.

Thus, since the second drive signal S3 is synchronized with the first drive signal S2, it effectively synchronizes the operations of the manipulating units 13 with the rotation of the conveyor actuator 14.

In an embodiment, each local control unit 137 is programmed to generate a secondary synchronization signal S4. The secondary synchronization signal S4 is a signal having a working period T4 which identifies the time needed to perform the work in the corresponding working station SL. The working period T4 whose value is the highest of all those of the different working stations SL is the pause period T2.

The other working stations each have a respective working period T4 that is less than T2.

The secondary synchronization signal S4 is synchronized with the primary synchronization signal S1; in effect, in an embodiment, the secondary synchronization signal S4 is started by the second drive signal S3, which is synchronized with the primary synchronization signal S1.

In other words, the secondary synchronization signal S4 might be viewed as a simulator of a virtual mechanical machine, in which a shaft rotates with a certain frequency, hence with a certain period, namely the working period T4.

This electronic stratagem allows gaining and defining a reference for programming the transmission of motion from the actuating unit 136 to the interface element 135 electronically, and not mechanically, as used to be done in the past.

In an embodiment, the local control unit 137 is programmed to receive configuration data representing the manipulating trajectory required for the interface element 135.

The configuration data therefore represent the predetermined law of motion for the interface element 15, which means that the law of motion is programmable.

For this purpose, the machine 1 comprises a user interface 16, configured to receive the configuration data from an operator and connected to the control unit 15 to send the configuration data entered.

In an embodiment, therefore, each local control unit 137 is programmed to generate a command signal S5 for each actuator of the respective actuating unit 136 as a function of the secondary synchronization signal S4 and the configuration data. The combination of the command signals S5 generated for each actuator of the respective actuating unit 136 causes the interface element 135 to perform a movement corresponding to the required manipulating trajectory in the working period T4.

The fully electronic control just described has big advantages in terms of machine flexibility, since the machine can be reconfigured to change the rotation speed, manipulating trajectory and one or more working periods by simply modifying the configuration data while leaving unchanged the relations (that is to say, in other terms, the electronic cams) existing between all the actuators of the machine 1.

In an embodiment, the configuration data include one or more of the following parameters:
a pickup point, expressed in planar Cartesian coordinates;
distance towards the pickup point, along a vertical direction;
distance away from the pickup point, along a vertical direction;
a set-down point, expressed in planar Cartesian coordinates;
distance towards the set-down point, along a vertical direction;
distance away from the set-down point, along a vertical direction;
a transition point between the pickup point and the set-down point, expressed in planar Cartesian coordinates;
a transition point between the set-down point and the pickup point, expressed in planar Cartesian coordinates.

In a preferred embodiment, the actuating unit 136 of at least one manipulating unit 13 comprises a first linear actuator 1361 that is movable along a first direction D1. In an embodiment, the actuating unit 136 of at least one manipulating unit 13 comprises a second linear actuator 1362 that is movable along a first direction, parallel to the first linear actuator. In an embodiment, the actuating unit 136 of at least one manipulating unit 13 comprises an external guard 1363 which houses the first and/or the second linear actuator 1361, 1362.

In an embodiment, the actuating unit 136 of at least one manipulating unit 13 comprises an articulated structure 1364. The articulated structure 1364 is connected to the interface element 135. The articulated structure 1364 is connected to the first linear actuator 1361. The articulated structure 1364 is connected to the second linear actuator 1362. The articulated structure 1364 is configured to convert a linear movement of the first actuator 1361 and second actuator 1362 into a movement of the interface element 135 along the manipulating trajectory. Preferably, the manipulating trajectory is contained in a plane.

More in detail, the first linear actuator 1361 is connected to a first rod A1 of the articulated structure 1364. The rod A1 is hinged to the first linear actuator 1361 and to the interface element 135.

The second linear actuator 1362 is connected to an articulated parallelogram A2 of the articulated structure 1364. The articulated parallelogram A2 is hinged to the second linear actuator 1362 and to the interface element 135.

The local control unit 137 is programmed to vary the position of the first and second linear actuators 1361, 1362 along the first direction D1 over time, so as to reproduce a movement of the interface element 135 according to the required manipulating trajectory.

According to an aspect of it, this disclosure also provides a method for assembling a plurality of components to make an assembly.

The method comprises a step of transporting. In the step of transporting, a conveyor 10 transports a first component along a working path PL, along which the first component is assembled with other components of the plurality of components. In an embodiment, the step of transporting comprises a step of rotating a turntable 101 that rotates about an axis of rotation R.

In an embodiment, the step of transporting comprises a step of linearly moving the conveyor 10, which is a linear conveyor 101′ that transports the components and the semi-assemblies along a rectilinear direction.

In the step of transporting, the conveyor 10 (the turntable 101 or the linear conveyor 101′) moves according to a succession of advances AV alternated with corresponding pauses SS. In an embodiment, the step of transporting has an assembling period T1, in which all the assembling operations are completed and the turntable 101 has completed one full rotation about the axis R.

The method comprises a step of feeding, in which a feed conveyor 11 conveys a first component from an external buffer, which contains a number of first components, to a position near the conveyor 10.

The method comprises a step of picking up, in which a pickup conveyor 12 conveys the assembly from a zone near the conveyor 10 to an external buffer, where the assemblies are stored.

The method comprises a step of manipulating, in which a plurality of manipulating units 13, each positioned in a respective working station SL along the working path PL, perform a corresponding operation on the components in a working zone ZL of the corresponding working station SL.

More specifically, the step of manipulating comprises one or more of the following steps:
a step of positioning;
a step of expelling;
a step of assembling;
a step of inspecting.

In an embodiment, in the step of positioning, a pickup unit 131 picks up the first component from the feed conveyor 11 and sets it down at a corresponding position 102 on the turntable 101 (or the linear conveyor 101′).

In an embodiment, in the step of expelling, a set-down unit 132 picks up the assembly from the turntable 101 (or from the linear conveyor 101′) and sets it down on the pickup conveyor 12.

In the step of assembling, an assembling unit 133 picks up a corresponding assembly component (second component) and assembles it with the component (or the semi-assembly) positioned on the turntable 101 (or on the linear conveyor 101′).

In the step of assembling, an interface element 135 grabs the corresponding component to be assembled with the component (or the semi-assembly) positioned on the turntable 101 (or on the linear conveyor 101′).

More specifically, the step of assembling comprises a step of moving the interface element 135 between a working position P1, where it is inside the corresponding working zone ZL, and a rest position P2, where it is outside the corresponding working zone ZL.

In an embodiment, the step of manipulating comprises a step of actuating, in which an actuating unit 136 moves the interface element 135 between the working position P1 and the rest position P2.

In the step of inspecting, an inspecting unit 134 captures a control parameter from a component or a (semi-)assembly. In an embodiment, the inspecting unit captures one or more of the following parameters:
a temperature of the component, semi-assembly or assembly;
a 2D and/or 3D image of the component, semi-assembly or assembly;
an internal pressure;
an electromagnetic emission of the component, semi-assembly or assembly.

The inspecting unit 134 checks the quality of a component to be assembled or the quality of a (semi-)assembly.

In an embodiment, in the step of transporting, a conveyor actuator 14 moves the conveyor 10. The conveyor actuator 14 moves the turntable 101 (or the linear conveyor 101′).

More specifically, the conveyor actuator 14 is started intermittently according to the succession of advances AV and pauses SS, in line with the pause times T2 and the advance times T3.

In an embodiment, the method comprises a step of controlling. In the step of controlling, a control unit 15 controls the operation of the machine 1; more specifically, it controls the movements of the conveyor actuator 14 and of the manipulating units 13 synchronously.

In effect, in a preferred embodiment, the conveyor actuator 14 is controlled electronically by the control unit.

In effect, in a preferred embodiment, each actuating unit 136 is controlled electronically.

In an embodiment, the method comprises, for each manipulating unit, a step of locally controlling. In the step of locally controlling, a local control unit 137 of the respective manipulating unit 13 controls the movement of the corresponding actuating unit 136 (or of the actuators of the corresponding actuating unit 136).

In an embodiment, in the step of controlling, the control unit 15 controls the conveyor actuator 14 electronically, responsive to a synchronizing signal.

The control unit controls the movement of the actuating units 136 according to a predetermined law of motion, defining the manipulating trajectory of each interface element 135. The control unit controls the movement of the actuating units 136 synchronously relative to the synchronizing signal.

Described in detail below is a possible embodiment of how the actuators of the machine 1 are controlled electronically.

In an embodiment, the control unit 15 generates a primary synchronization signal S1. The primary synchronization signal S1 is a signal having a certain periodicity, equal to the assembling time T1. The primary synchronization signal S1 simulates the behaviour of a virtual mechanical machine in which a shaft rotates with a certain frequency, hence with a certain period, namely the assembling period T1.

The control unit 15 therefore generates a first drive signal S2 as a function of the primary synchronization signal S1. The control unit 15 generates the first drive signal S2 as a function of configuration data representing the rotation speed required by the operator and/or the number of stations n, where modifying this number is possible.

In other words, using the primary synchronization signal S1 as a reference, the control unit sets a corresponding value of the first drive signal at each instant of rotation of the virtual machine so as to determine a movement or an interruption of the conveyor actuator 14, in the same way as for mechanical cams.

Therefore, the control unit 15 sends the first drive signal S2 to the conveyor actuator 14 to instruct it to drive the conveyor 10 (that is, the turntable 101).

In an embodiment, for each manipulating unit 13, the control unit 15 generates a second drive signal S3. The second drive signal S3 is sent to the respective local control unit 137, to instruct it to start the corresponding operation at the working station SL. In other words, the second drive signal S3 provides a start signal for each manipulating unit (or a single start signal for all the manipulating units the instant the conveyor actuator 14 interrupts the advancing of the turntable 101) in order to start the corresponding operation.

Therefore, the control unit 15 synchronizes the movement (the rotation) of the conveyor actuator 14 with the operations of the manipulating units 13. In an embodiment, each local control unit 137 generates a secondary synchronization signal S4. The secondary synchronization signal S4 is a signal having a working period T4 which identifies the time needed to perform the work in the corresponding working station SL.

The control unit synchronizes the secondary synchronization signal S4 with the primary synchronization signal S1. In effect, in an embodiment, the secondary synchronization signal S4 is started by the second drive signal S3, which is synchronized with the primary synchronization signal S1. The secondary synchronization signal S4 is also a simulation of a virtual mechanical machine, in which a shaft rotates with a certain frequency, hence with a certain period, namely the working period T4. In an embodiment, the local control unit 137 receives configuration data representing the manipulating trajectory required for the interface element 135.

The step of controlling comprises a step of configuring, in which an operator, through a user interface, enters the configuration data and/or a required manipulating trajectory.

In an embodiment, therefore, each local control unit 137 generates a command signal S5 for each actuator of the respective actuating unit 136 as a function of the secondary synchronization signal S4 and the configuration data. Each local control unit 137 sends the command signals S5 to each actuator of the respective actuating unit 136 to instruct it to move the interface element 135 according to the required manipulating trajectory in the working period T4.

In a preferred embodiment, in the step of actuating, a first linear actuator 1361 of the actuating unit 136 of at least one manipulating unit 13 moves along a first direction D1. In a preferred embodiment, in the step of actuating, a second linear actuator 1362 of the actuating unit 136 of at least one manipulating unit 13 moves along the first direction D1.

In the step of actuating, an articulated structure 1364 converts a linear movement of the first actuator 1361 and second actuator 1362 into a movement of the interface element 135 along the manipulating trajectory. More in detail, a first rod A1 rotates about a hinge relative to the first linear actuator 1361 and about a hinge relative to the interface element 135. An articulated parallelogram A2 of the articulated structure 1364 also rotates about a hinge relative to the second linear actuator 1362 and about a hinge relative to the interface element 135.

The local control unit 137 varies the position of the first and second linear actuators 1361, 1362 along the first direction D1 over time, so as to reproduce a movement of the interface element 135 according to the required manipulating trajectory.

1.-16. (canceled)

17. A machine for the automatic, continuous-cycle assembling of a plurality of components for making an assembly, the machine comprising:
a conveyor, which is movable to transport a first of the plurality of components along a working path through a succession of advances alternated with a corresponding succession of pauses to define a corresponding plurality of working stations;
a conveyor actuator, configured to drive the conveyor so it moves intermittently between the working stations of the plurality of working stations;
one or more manipulating units, each positioned in a respective working station along the working path and each configured to perform a corresponding operation on the components in a working zone of the respective working station,
wherein each manipulating unit includes an interface element which is movable along a manipulating trajectory between a working position, where it is inside the corresponding working zone, and a rest position, where it is outside the corresponding working zone, and an actuating unit which is configured to move the interface element between the working position and the rest position, and
wherein at least one manipulating unit is configured to pick up a second component of the plurality of components and to assemble it with the first component positioned on the conveyor; and
a control unit, configured to electronically control the conveyor actuator in response to a synchronization signal, wherein the actuating units include actuators which are electronically controllable and wherein the control unit is programmed to control a movement of the actuating units according to a predetermined law of motion, defining the manipulating trajectory of each interface element, and synchronously with the synchronization signal.

18. The machine according to claim 17, wherein the control unit is programmed to generate a primary synchronization signal and to generate drive signals as a function of the primary synchronization signal, to command the conveyor actuator to move the conveyor, wherein the primary synchronization signal represents a step defined by the succession of advances of the conveyor.

19. The machine according to claim 18, wherein each actuating unit includes:
a first linear actuator and a second linear actuator which are movable along a first direction; and
an articulated structure, connected to the interface element, to the first linear actuator and to the second linear actuator and configured to convert a linear movement of the first actuator and second actuator into a movement of the interface element along the manipulating trajectory, where the manipulating trajectory is contained in a plane.

20. The machine according to claim 17, wherein each actuating unit comprises a real actuator configured to drive the interface element, and wherein the control unit is programmed to generate, for each manipulating unit, a respective command signal as a function of the primary synchronization signal and the respective predetermined law of motion, to instruct the respective real actuator to drive the corresponding interface element.

21. The machine according to claim 17, comprising, for each actuating unit, a local control unit, programmed to generate a secondary synchronization signal, synchronized with the primary synchronization signal, and wherein each local control unit is configured to generate command signals in response to the secondary synchronization signal to instruct the real actuator to drive the interface element.

22. The machine according to claim 17, wherein the predetermined law of motion is programmable and wherein the machine comprises a user interface connected to the control unit to receive configuration data representing the predetermined interface element of at least one manipulating unit.

23. The machine according to claim 22, wherein the configuration data represent the manipulating trajectory of the interface element of each manipulating unit and include one or more of the following parameters:
a pickup point, expressed in planar Cartesian coordinates;
distance towards the pickup point, along a vertical direction;
distance away from the pickup point, along a vertical direction;
a set-down point, expressed in planar Cartesian coordinates;
distance towards the set-down point, along a vertical direction;
distance away from the set-down point, along a vertical direction;
a transition point between the pickup point and the set-down point, expressed in planar Cartesian coordinates; or
a transition point between the set-down point and the pickup point, expressed in planar Cartesian coordinates.

24. The machine according to claim 17, comprising a plurality of sensors configured to detect one or more physical quantities on the assembled components.

25. The machine according to claim 17, wherein the conveyor is a linear conveyor, wherein the working path comprises at least one rectilinear portion.

26. The machine according to claim 17, wherein the conveyor is a turntable, and wherein the working path is at least one portion of a circle.

27. The machine according to claim 17, wherein the one or more manipulating units comprise one or more of the following features:
a pickup unit configured to pick up a component and to place it on the conveyor;
a set-down unit, configured to pick up an assembly from the conveyor and to set it down outside the machine;
an assembling unit, configured to pick up a component to be assembled from a loading bay and to assemble it with the component positioned on the conveyor; or
an inspecting device, configured to capture a control parameter from the component or assembly to perform a quality check.

28. The machine according to claim 17, wherein the control unit is programmed to generate a primary synchronization signal and wherein each actuating unit comprises a real actuator configured to drive the interface element, and a local control unit, programmed to generate a secondary synchronization signal, synchronized with the primary synchronization signal, and wherein each local control unit is configured to generate command signals in response to the secondary synchronization signal to instruct the real actuator to drive the interface element.

29. A method for the automatic, continuous-cycle assembling of a plurality of components for making an assembly, the method comprising the following steps:
transporting, on a conveyor, a first of the plurality of components along a working path through a succession of advances alternated with a corresponding succession of pauses to define a corresponding plurality of working stations;
actuating a conveyor actuator to drive the conveyor so it moves intermittently between the working stations of the plurality of working stations;
with one or more manipulating units, performing a corresponding operation on the components in a working zone of the respective working station; wherein at least one of the operations is an operation of assembling a second component with the first component;
with an actuating unit, moving an interface element of each of the one or more manipulating units between a working position, where it is inside the corresponding working zone, and a rest position, where it is outside the corresponding working zone; and
with a control unit, electronically controlling the conveyor actuator and the actuating units in response to a synchronization signal and according to a predetermined law of motion to define the manipulating trajectory of each interface element, and synchronously with the synchronization signal.

30. The method according to claim 29, wherein in the step of controlling, the control unit generates a primary synchronization signal and drive signals as a function of the primary synchronization signal, and sends the drive signals to the conveyor actuator to instruct it to drive the conveyor, wherein the primary synchronization signal represents a step defined by the succession of advances of the conveyor.

31. The method according to claim 30, wherein in the step of controlling, for each manipulating unit, the control unit generates command signals, in response to the synchronization signal and the predetermined law of motion, to instruct a real actuator of the corresponding manipulating unit to drive the respective interface element.

32. The method according to claim 29, wherein the method comprises a step of inspecting, wherein at least one manipulating unit of the one or more manipulating units is an inspecting unit which captures a control parameter from the component or assembly to perform a quality check.

33. A machine for the automatic, continuous-cycle assembling of a plurality of components for making an assembly, the machine comprising:
a conveyor, which is movable to transport a first of the plurality of components along a working path through a succession of advances alternated with a corresponding succession of pauses to define a corresponding plurality of working stations;
a conveyor actuator, configured to drive the conveyor so it moves intermittently between the working stations of the plurality of working stations;
one or more manipulating units, each positioned in a respective working station along the working path and each configured to perform a corresponding operation on the components in a working zone of the respective working station,
wherein each manipulating unit includes an interface element which is movable along a manipulating trajectory between a working position, where it is inside the corresponding working zone, and a rest position, where it is outside the corresponding working zone, and an actuating unit which is configured to move the interface element between the working position and the rest position, and
wherein at least one manipulating unit is configured to pick up a second component of the plurality of components and to assemble it with the first component positioned on the conveyor;
the machine comprising a plurality of sensors configured to detect one or more physical quantities on the assembled components.

34. The machine according to claim 33, comprising a control unit, configured to electronically control the conveyor actuator, in response to a synchronization signal, wherein the actuating units include actuators which are electronically controllable and wherein the control unit is programmed to control a movement of the actuating units according to a predetermined law of motion, defining the manipulating trajectory of each interface element, and synchronously with the synchronization signal.

35. The machine according to claim 34, wherein the control unit is programmed to generate a primary synchronization signal and to generate drive signals as a function of the primary synchronization signal, to command the conveyor actuator to move the conveyor, wherein the primary synchronization signal represents a step defined by the succession of advances of the conveyor.

36. The machine according to claim 35, wherein each actuating unit includes:
a first linear actuator and a second linear actuator which are movable along a first direction; and
an articulated structure, connected to the interface element, to the first linear actuator and to the second linear actuator and configured to convert a linear movement of the first actuator and second actuator into a movement of the interface element along the manipulating trajectory, where the manipulating trajectory is contained in a plane.
